(19) United States
(12) Patent Application Publication
(10) Pub. No.: US 2005/0208193 A1
(43) Pub. Date: Sep. 22, 2005

(54) Mozzarella-type string cheese product

(75) Inventors: Eduardo Cortes-Martinez, Munich (DE); Angela Schroeder, Miesbach (DE); Alan Wolfschoon, Freising (DE); Thomas Schmid, Thedinghausen (DE); David Mehnert, Lake Villa, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods R&D, Inc.

(21) Appl. No.: 11/076,349

(22) Filed: Mar. 9, 2005

(30) Foreign Application Priority Data
Mar. 17, 2004 (EP) EP 04006331.5

(51) Int. Cl. A23C 19/00

(52) U.S. Cl. 426/582

(57) ABSTRACT

The invention provides a process for providing Mozzarella-type string cheese products having sufficiently good mouthfeel and textural properties so as to be suitable for direct consumption by a consumer.

### FIELD OF THE INVENTION

The invention relates to a process for manufacturing Mozzarella-type string cheese products and to the cheese products made by this process. The process of this invention provides Mozzarella-type string cheese products having an improved mouthfeel and which are more attractive for direct consumption.

### BACKGROUND OF THE INVENTION

String cheese is a Mozzarella-type cheese product which is shaped by extrusion. The conventional process for manufacturing Mozzarella-type cheese products, including string cheese products, consists of pasteurizing cow or buffalo milk, acidifying the milk to convert it to a cheese milk, coagulating the cheese milk to obtain a coagulum comprised of curd and whey, cutting the coagulum, and draining the whey therefrom, thereby leaving a cheese curd, heating, kneading, and stretching the cheese curd until it is a homogeneous, fibrous mass of heated, unripened cheese, shaping the heated cheese, cooling the shaped cheese in cold brine, and removing the cooled cheese from the brine. Such a process is known, for example, from U.S. Pat. No. 5,380,543 and WO 96/25051.

The heating, kneading, and stretching of the cheese curd is typically carried out in a piece of equipment called a hot water mixer/cooker. The temperatures used for heating, kneading, and stretching of the cheese curd are generally less than about 90° C. Example 1 of WO 96/25051, for example, mentions a temperature of 49° C.

The texture of the extruded Mozzarella-type cheese products is fibrous and somewhat rubbery. However, the texture of Mozzarella-type cheese products has not been of great concern because Mozzarella cheese is mostly used for baking purposes, (e.g., producing pizzas) where high baking temperatures are used and where the structure and texture of the Mozzarella cheese is completely altered.

Extruded Mozzarella-type cheese products, however, are not very attractive for direct consumption by consumers because of their fibrous and somewhat rubbery texture.

It is the object of the present invention to provide a process for manufacturing extruded Mozzarella-type cheese products, (e.g., string cheese products) which have an improved mouthfeel and are more attractive for direct consumption.

### SUMMARY OF THE INVENTION

The invention relates to a process for manufacturing a Mozzarella-type string cheese product comprising the steps of
(a) providing cheese curd,
(b) heating, kneading, and stretching the cheese curd together with any desirable ingredients in a direct steam injected mixer/cooker using steam injected directly into the cheese curd and sufficient mixing to maintain the temperature at less than about 70° C. to obtain a cheese product,
(c) extruding the cheese product, and
(d) cooling the extruded cheese product to obtain the Mozzarella-type string cheese product,
wherein the Mozzarella-type string cheese product has sufficiently good mouthfeel and textural properties to be suitable for direct consumption by a consumer. Preferably, the extruded cheese product is cooled using cold brine. The invention also relates to Mozzarella-type string cheese products manufactured by the process as described above.

### DETAILED DESCRIPTION

The use of a steam injection mixer/cooker and direct steam injection for the heating, kneading, and stretching of the cheese curd leads to a Mozzarella-type cheese product which, especially when extruded, has a greatly improved texture and a much better mouthfeel. The Mozzarella-type cheese product produced in this invention is much more attractive for direct consumption by consumers, as established by consumer tests.

The use of steam injection is known in the production of processed cheese where much higher temperatures are needed and where no extrusion of the final product is involved. It could not be foreseen that the use of steam injection during heating, kneading, and stretching of a cheese curd would lead to a cheese mass which, despite its extrusion, is no longer fibrous or rubbery. It is believed that the fibrous texture of known extruded Mozzarella-type cheese products is, at least in part, caused by the extrusion step. Therefore, it is very surprising that the extrusion step within the process of the present invention does not cause the undesired fibrous texture of the Mozzarella cheese and it is further surprising that the string cheese product is no longer rubbery.

An additional advantage of the process of the present invention is brought about by the possibility of adding a much greater variety of different ingredients during the heating, kneading, and stretching step, which was not possible with the known use of a hot water mixer/cooker without steam injection.

The process for manufacturing Mozzarella-type cheese products is well-known as mentioned above and the steps of making cheese curd, heating, kneading, and stretching the cheese curd in a commonly used mixer/cooker, shaping and especially extruding the cheese product, and cooling the cheese product in cold brine are well described in the above-mentioned U.S. Pat. No. 5,380,543 and WO 96/25051, both of which are hereby incorporated by reference.

The use of a steam injection mixer/cooker in the heating, kneading, and stretching step will now be described in more detail. In the conventional process for making Mozzarella-type cheese in a hot water mixer/cooker using hot water as the heat source, pieces of cheese curd and other ingredients are introduced into a container provided with paddles or stirring arms. A volume of hot water having a temperature in the range of 60 to 90° C., typically 80° C., is added, thereby covering the raw material. The components are kneaded by the action of the paddles until they melt and aggregate to each other and finally create a homogeneous elastic mass. An alternative to the batch production is the use of a continuous hot water cooker. In this system, the cheese does not remain in a specific location while being kneaded, but is transported through the hot water by means of screws along a pipe. The melting/stretching/homogenization of the mass is done during the time the cheese needs to reach the exit of the cooker.

In the process of the present invention, the ingredients are charged into a batch mixer/cooker which is preferably provided with a double-screw system. The ingredients are pieces of fresh or aged cheese curd (preferably aged less than about 8 days) and emulsifying salts such as sodium citrate in an amount of up to about 1% by weight. Other optional ingredients are dairy ingredients such as milk protein, skimmed milk powder (SMP), and the like, as well as non-dairy ingredients such as coloring agents, flavoring agents, meat pieces, nuts, and the like, and water. The ingredients are then mixed until they reach a homogeneous distribution.

Steam is then directly applied to the mass by means of injectors which are preferably positioned at the bottom of the cooker. The steam, together with the mechanical effect of the screws, starts melting and emulsifying the cheese mass while preventing the degradation of the fresh protein. The cheese mass should be kept below a temperature of about 70° C. The cheese mass preferably reaches a temperature of about 60 to about 67° C., typically about 64° C. The steam is injected at a pressure of preferably about 2 bar absolute, a pressure range of about 1.5 to about 2.5 bar absolute being possible. The temperature of the steam is preferably in a range of about 120° C. to about 150° C., preferably about 130° C.

The mixing speed or mixing energy input should be relatively high during the time of steam injection in order to avoid local overheating. The steam injection should be terminated when the cheese mass reaches the above-mentioned temperature ranges, preferably once the temperature reaches about 60 to about 67° C., in order to avoid degradation.

After reaching the desired temperature, mixing and stretching the cheese mass is continued for several minutes without steam injection. The resulting cheese mass can be transferred to a conventional extruder to produce the desired string cheese product.

The string cheese products made according to the process of the present invention have a texture which is particularly pleasant, melts in mouth, and is not fibrous. This is a very surprising and striking result which makes the products according to the invention much more acceptable for direct consumption. It is no longer fibrous and not rubbery.

Moreover, the use of steam injection increases the possibility of using many more ingredients which were unable to be introduced into Mozzarella-type cheese products up to now. This leads to an added increase of consumer acceptance.

The following example illustrates the process according to the invention and is not limiting.

Example. Cheese curd was cut into pieces by means of a dicer, and loaded into the double-screw direct steam injection cooker/mixer (Inotec ISM-250DV, total capacity: 250 liters). The cheese curd was of the “Cagliatta” type and was produced using cultures. The remaining ingredients (dairy proteins concentrate powder (about 12 percent), calcium milk powder (about 1.8 percent), sodium citrate (about 1 percent), coloring agents (about 0.005 percent), and water (about 12 percent) were weighed separately. The powders were then introduced into the cooker/mixer together with the cheese pieces (about 73 percent), and dry-mixed for 1 minute at 40% speed (about 30 rpm). Water and coloring agents were then added and mixing was continued for another minute at the same speed to obtain a wet mix. The total batch size was 175 kg.

Immediately after mixing, steam was directly applied to the wet mix mass by means of 4 injectors which were positioned at the bottom of the cooker. The steam, together with the mechanical effect of the screws, began melting/emulsifying the cheese mass. Heating and mixing was continued until the cheese mass reaches 65° C. When the cheese reached 65° C., mixing was continued (without steam) for another 1.5 minutes (at about 55 rpm) in order to complete homogenization in the cooked cheese mix. At this point, the cheese mix was ready to start the shaping and cooling process steps.

The cheese mass was downloaded into a double-jacketed (40° C. water temperature) extruder, which applied a pressure to the cheese mass (about 0.8-1 bar), forcing it through a double-jacketed extruder head (70° C.) with 15 mm diameter nozzles, to create a continuous cheese rope. The cheese rope fell into a channel with a flow of cold brine (18% salt content, 5° C.) and was transported to a cutting system (knives activated by an optic sensor) which cut the cheese rope into cheese sticks (11 cm long).

The cheese sticks then fell into another brine bath to complete the cooling (down to 7° C.) and salting (to 1.6% NaCl in the final product) process during 8 minutes of residence time, proceeding finally to the packaging machine and storage under refrigeration conditions.

Consumer tests with respect to aroma, appearance, texture, taste, and aftertaste and revealed a significant improvement in all respects compared with conventionally produced string cheese. The various organoleptic properties (e.g., texture, aroma, taste, appearance, aftertaste, and the like) improved by 13 to 34%, with the overall acceptance improving by 22%. The most striking improvement is the much more pleasant texture which is no longer fibrous and rubbery.

1. A process for manufacturing a Mozzarella-type string cheese product comprising the steps of
(a) providing cheese curd,
(b) heating, kneading, and stretching the cheese curd together with any desirable ingredients in a direct steam injection mixer/cooker using direct steam injection into the cheese curd with sufficient mixing to maintain the temperature of the cheese curd at less than about 70° C. to obtain a cheese product,
(c) extruding the cheese product, and
(d) cooling the extruded cheese product to obtain the Mozzarella-type string cheese product,
wherein the Mozzarella-type string cheese product has sufficiently good mouthfeel and textural properties to be suitable for direct consumption by a consumer.

2. The process according to claim 1, wherein the extruded cheese product is cooled in cold brine.

3. The process according to claim 2, wherein steam is injected into the cheese curd at a pressure of about 1.5 to about 2.5 bar.

4. The process according to claim 3, wherein steam is injected at a pressure of about 2 bar.

5. The process according to claim 3, wherein steam is injected until the temperature of the cheese curd is about 60 to about 67° C.

6. The process according to claim 5, wherein steam is injected until the temperature is about 64° C.

7. The process according to claim 2, wherein the injected steam has a temperature of about 120 to about 150° C.

8. The process according to claim 3, wherein the injected steam has a temperature of about 120 to about 150° C.

9. The process according to claim 5, wherein the injected steam has a temperature of about 120 to about 150° C.

10. A Mozzarella-type string cheese product manufactured by a process comprising the steps of
(a) providing cheese curd,
(b) heating, kneading, and stretching the cheese curd together with any desirable ingredients, in a direct steam injection mixer/cooker using direct steam injection with sufficient mixing to maintain the temperature of the cheese curd at less than about 70° C. to obtain a cheese product,
(c) extruding the cheese product, and
(d) cooling the extruded cheese product to obtain the Mozzarella-type string cheese product,
wherein the Mozzarella-type string cheese product has sufficiently good mouthfeel and textural properties to be suitable for direct consumption by a consumer.

11. The Mozzarella-type string cheese product of claim 10, wherein the extruded cheese product is cooled in cold brine.

12. The Mozzarella-type string cheese product of claim 11, wherein steam in injected into the cheese curd at a pressure of about 1.5 to about 2.5 bar.

13. The Mozzarella-type string cheese product of claim 11, wherein steam is injected into the cheese curd at a pressure of about 2 bar.

14. The Mozzarella-type string cheese product of claim 12, wherein steam is injected until the temperature of the cheese curd is about 60 to 67° C.

15. The Mozzarella-type string cheese product of claim 14, wherein steam is injected until the temperature of the cheese curd is about 64° C.

16. The Mozzarella-type string cheese product of claim 11, wherein the injected steam has a temperature of about 120 to about 150° C.

17. The Mozzarella-type string cheese product of claim 12, wherein the injected steam has a temperature of about 120 to about 150° C.

18. The Mozzarella-type string cheese product of claim 14, wherein the injected steam has a temperature of about 120 to about 150° C.
